(19) United States
(12) Patent Application Publication
(10) Pub. No.: US 2008/0276903 A1
(43) Pub. Date: Nov. 13, 2008

(54) Viktor Gorb's Rotary Internal Combustion Engine

(76) Inventors: Viktor Mykalayovych Gorb, Dnepropetrovsk (UA); Olexandr Viktorovych Gorb, Dnepropetrovsk (UA)

Correspondence Address: ALEKSANDR SMUSHKOVICH, POB 140505, BROOKLYN, NY, 11214, US

(21) Appl. No.: 11/884,249

(22) PCT Filed: Feb. 7, 2006
(86) PCT No.: PCT/UA2006/000006

§ 371 Date: Apr. 10, 2008

(51) Int. Cl. F02B 53/00

(52) U.S. Cl. 123/243

(57) ABSTRACT

A rotary internal combustion engine is provided, comprising one or more modules mounted on a common shaft, each module comprising a rotor, a stator, an ignition system, a working chamber, an exhaust gas discharge system, and a system of seals. The engine is characterized in that the working chamber, together with the fuel mixture mixer, inlet port and the ignition system, are disposed externally of the stator, and oriented tangentially to said stator the stator being of a cylindrical type, with its axle somewhat offset from the rotor axle, the rotor also comprising a working vane and a suction vane serving both as a working means and a seal; each engine module also including a maintenance manhole with a seal and an exhaust port.

### CROSS-REFERENCE TO RELATED APPLICATIONS

This application is a U.S. national phase application of a PCT application PCT/UA2006/000006 filed on 7 Feb. 2006, whose disclosure is incorporated herein in its entirety by reference.

### FIELD OF THE INVENTION

The invention relates to power and transportation mechanical engineering, and rotary internal combustion engines in particular.

### BACKGROUND OF THE INVENTION

The prototype (closest prior art device) of the provided invention is a rotary internal combustion engine (according to Patent No. RU2175397, Cl. A02B53/00, published in 2001) comprising two or more rotor modules of profiled rotors mounted on a common shaft, a shutter with a piston, sealing means, a hull with an opening used to draw working medium into a compression chamber and discharge the exhausted working medium from an idle chamber, as well as to intake the working medium under pressure from a similar rotor module. The shutter separates the working chamber from the idle chamber created by one side of the shutter and the rotor's lobe (protrusion). The shutter with the piston form channels for discharging the exhaust medium from the idle chamber and expelling the working medium under pressure from another operating module. A spark-plug is provided for operating this engine as an internal combustion engine. The shutter is in continuous contact with the rotor's external surface depressed by a spring disposed in the hull compression chamber and acting upon the piston bottom. The hulls with the compression chambers in certain rotor modules operate as fuel pumps.

However, the aforesaid engine features a complicated design and has several disadvantages. In particular, aforesaid engine has no automatic fuel mixture injection system, and so the fuel mixture has to be forcefully fed into the working chamber making the engine operation more difficult.

In the aforesaid engine, as well as in many other engines, the rotor is the principal operating member, and upon its wearing out, the whole engine requires a major repair with full replacement of the corresponding module. Therefore, this configuration requires a large number of seals, making the engine design very complicated for manufacture and operation. Furthermore, the aforesaid seals hinder rotation of the rotor. In rotation, the rotor beats against the seals and quickly wears out. Besides, the rotor in the aforesaid engine is asymmetric, and, therefore, a substantially constant parasitic force is generated during its rotation, directed from the centre of rotation. The higher the rotor speed, the larger is this force, imposing an additional load on the main shaft and causing the engine vibration. Any failure in any of the modules compromises the normal and efficient operation of the remaining modules. Employment of a single module requires additional design solutions leading to a higher cost and renders the design less reliable.

### BRIEF SUMMARY OF THE INVENTION

The object of this invention is to create a simpler engine configuration to improve the engine efficiency and commercial applicability, simplify its operation and maintenance, extend its service life (lifespan), and increase its capacity.

The aforesaid object is attained in that the rotary internal combustion engine comprises one or more modules mounted on a common shaft rotatable within the engine; each module including: a stator stationed within the engine, a rotor substantially coupled to the common shaft; an ignition system, a working chamber furnished with an intake collector and a fuel mixture mixer, an exhaust gas discharge system, and a system of seals.

According to the invention, the working chamber, together with the fuel mixture mixer, intake collector (inlet port) and ignition system, are disposed externally of the stator, and oriented tangentially to the aforesaid stator, the rotor being of a cylindrical type, is disposed within the stator, with the rotor's longitudinal axis being somewhat offset from the stator's longitudinal axis; the rotor also comprising a working vane and a suction vane serving both as an operating member and a seal; each engine module also including a maintenance manhole with a seal and an outlet (exhaust) port.

Since the working chamber is disposed externally to the stator, and oriented tangentially to the aforesaid stator, the explosion of the fuel mixture is directed onto the working vane allowing the employment of the blast wave in addition to the power of compressed fuel medium (as used in the prototype design). Hence, this results in advanced fuel efficiency and superior fuel economy over the prototype design, or, an improved capacity, assuming that the fuel is used in the same amount. Furthermore, this allows for easily enhancing the engine capacity (increasing the working chamber volume), for modifying the working chamber not affecting either the rotor or the stator, or implementing changes of the engine parameters adapting them for specific needs (e.g. achievement of a better fuel economy or adaptation for a particular working medium, i.e. fuel type).

The rotor is designed so that having a normal cylindrical shape (unlike that in the prototype design, having an asymmetrical oval shape with a lobe), its axis of rotation coincides with the symmetry centerline and is offset from the stator longitudinal axis. The stator also has a cylindrical shape although of a larger diameter, so that embracing the aforesaid rotor. The symmetrical rotor, in its rotation, produces no beating (throbbing) effect, requires no balancing counterweight, and in practice produces no additional vibrations. The engine is easily operated with one module only, and allows for adding any number of modules by placing them at any angles with respect to each other without ant adjustment or balancing. Essentially, this engine design offers simplicity, reliability and low cost.

In the proposed engine configuration, no limitations are imposed on the motion by wearing and rubbing (friction-pair) members. The working vane, the suction vane, and the seal (one only) are compressed against the rotor's external surface with a spring thus eliminating any beat or throbbing (taking place in the prototype design). Gradually, upon wearing out, the aforesaid members are pushed out by the spring, still remaining depressed against the stator's internal surface (both vanes) and the rotor's external surface (seal), and not affecting the operation mode of the chambers.

Herein, the actual travel margin can be several centimeters. Under similar operating conditions, a member with a friction margin of, for example, 0.5 mm will fail by far earlier than a member with a friction margin of 20 mm and higher. The length tolerance requirement at the time of manufacture of the seals and vanes can therefore be relaxed. In practice, this means it is possible to use half- or almost worn-out members alongside brand new ones in the same module with no impact on operation or efficiency.

Instead of a directly employed rotor (as it's done in the prototype design), the vanes are used herein as the principal operating members (being depressed and pushed by the working medium, i.e. gas); the aforesaid vanes having a simple design and allowing for an easy replacement using the maintenance manhole, thus reducing maintenance costs and extending the service life. The maintenance manhole together with the seal serve a dual purpose allowing to replace the working and suction vanes and springs without dismantling the engine, and providing a sealing function between the rotor and the stator.

### BRIEF DESCRIPTION OF DRAWINGS

FIG. 1 is an isometric view that shows an overall design of the engine, according to the present invention;

FIG. 2 is a sectional view that shows a transverse cross-section of an engine module during a stroke, according to the present invention;

FIG. 3 is a sectional view that shows a longitudinal cross-section of an engine module, according to the present invention.

Identical reference numerals in the drawings generally refer to the same or similar elements in different figures.

### EXEMPLARY DESCRIPTION OF A PREFERRED EMBODIMENT OF THE INVENTION

While the invention may be susceptible to embodiment in different forms, there is shown in the drawings, and will be described in detail herein, a specific embodiment of the present invention, with the understanding that the present disclosure is to be considered an exemplification of the principles of the invention, and is not intended to limit the invention to that as illustrated and described herein.

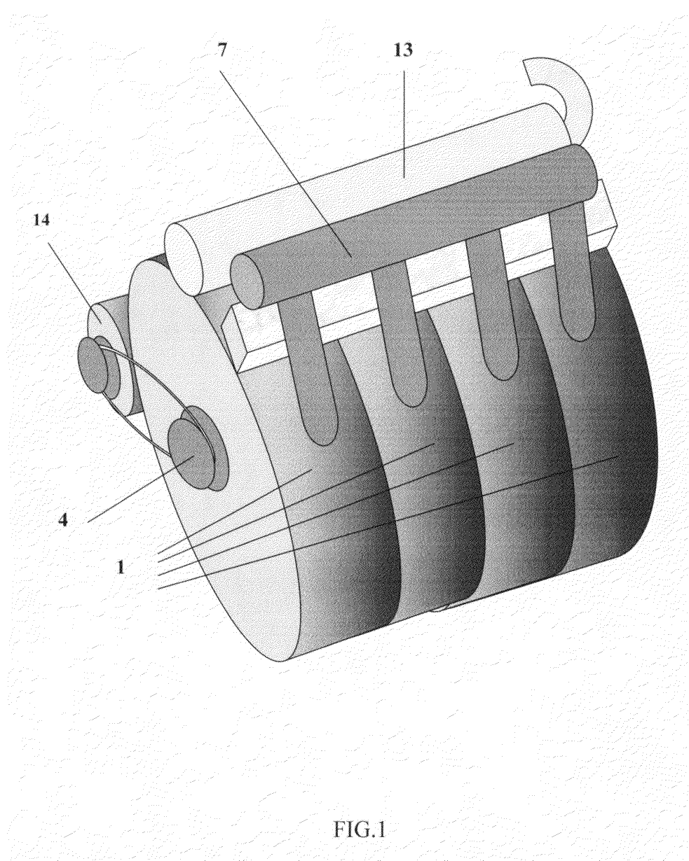

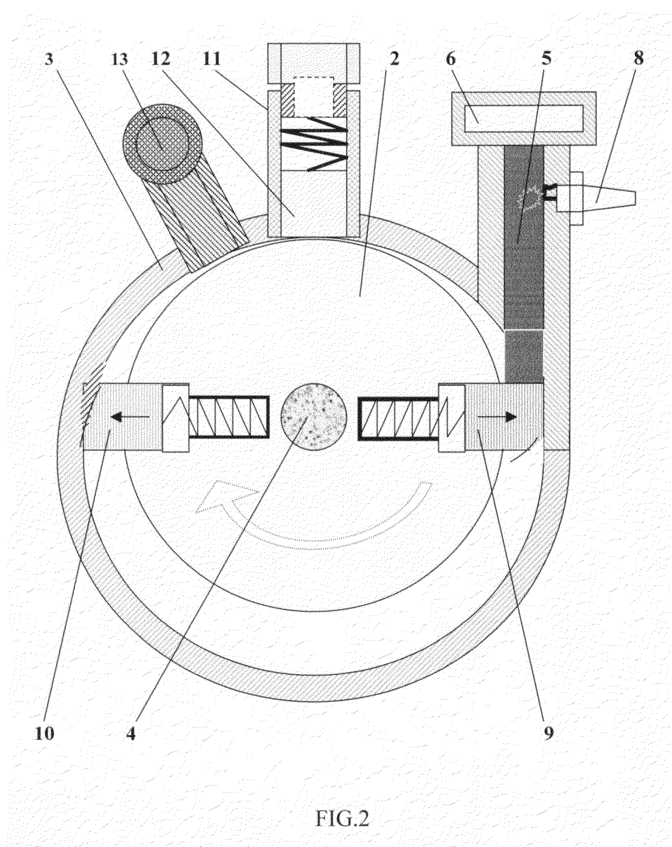

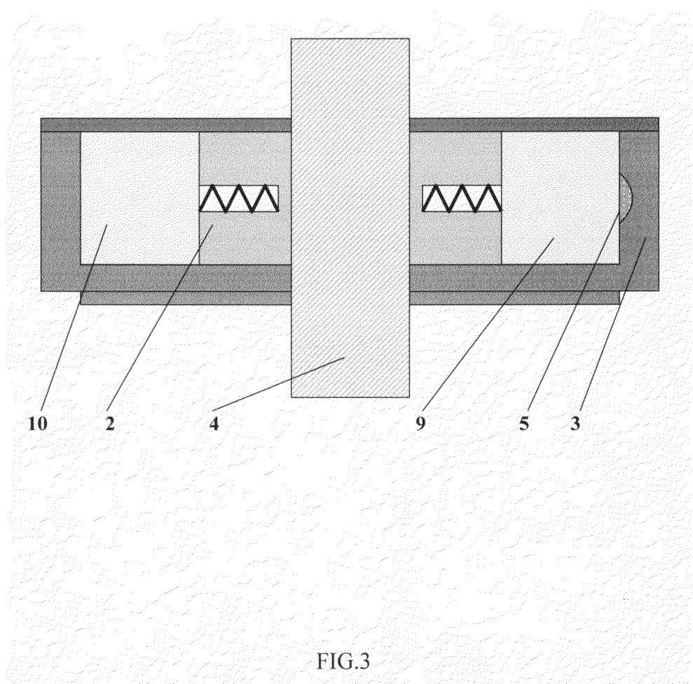

A preferred embodiment of the inventive rotary internal combustion engine (illustrated in FIGS. 1, 2, 3) comprises at least one module (1) mounted on a common shaft (4). Each module includes a rotor (2) and a stator (3). The engine comprises a working (explosion) chamber (5) in conjunction with a working mixture mixer (6), an intake collector (7) and an ignition system (8) mounted tangentially to the stator (3). The ignition system is fed by an electric generator (14) driven by the common shaft (4). The rotor (2) includes a working vane (9) and a suction vane (10) springly depressed against the internal surface of the stator. Each module also includes a maintenance manhole (11) with a seal (12) springly depressed against the external surface of the rotor and an exhaust port (13) for removal of the exhaust gases.

### OPERATION OF THE EXEMPLARY EMBODIMENT

The disclosure hereunder is based on an embodiment comprising a single module, shown on FIGS. 1, 2, 3. The operative process of the engine is as follows. When the working mixture in the working chamber (5) is ignited, a directed explosion of the aforesaid mixture takes place. The force, produced by the explosion and exerted onto the working vane (9) causes the rotor (2) to rotate and perform its intended function. Upon a 180-degree rotation of the rotor (2), the suction vane (10) draws the working medium into the working chamber (5) through the intake collector (7) of the mixer (6) in the amount controlled by the intake collector (7) of the working medium mixer (6). Upon another 180-degree rotation of the rotor (2), the suction vane additionally expels the exhaust gas from the exhaust port (13), whereas the working vane (9) shuts off the working chamber (5), the pressure therein equalizes, and the intake collector (7) in the working medium mixer (6) is shut off by the spring, whereupon the ignition system (8) is actuated and another stroke is accomplished. The working cycle of the engine takes one full turn of the rotor (2).

The maintenance manhole (11) together with the seal (12) serve a dual purpose allowing to replace the working vane (9) and the suction vane (10) with their corresponding springs without dismantling the engine, and providing a sealing means between the rotor (2) and the stator (3). The engine travel is about 270 degrees. Any fuel providing a volumetric expansion at ignition (petrol, diesel fuel, gas, etc) can be used as working medium, in addition to compressed air and vapour. Furthermore, exhausted working medium from any module can be used by the next module in the arrangement, provided that this module has no external working chamber.

The proposed engine is nearly noiseless at idle running and produces a negligibly low level of dangerous emissions. At power excess, a compressor is actuated automatically to replenish the supply of air. The proposed engine features from 3 to 4 times lower the fuel consumption rate, when compared to other similar engines providing the same capacity.

The simple design results in high reliability and fail-safety. A failure of any parts in one or more modules or any cracks/breaks in the housing or the shaft bearing, the modules will lead to a loss of capacity, without stopping the engine. The engine is relatively light, allowing to mount spare engines. This engine, unlike the prototype configuration, requires no intricate solutions to provide a seal between the rotor and the stator, and is readily manufactured.

Fuel economy achieved in the proposed engine is comparable to that of electric motors allowing to use said engine at power stations in a variety of applications including plants, pumps, camps, filling stations, natural gas/oil products transmission stations, compressor stations, etc. Changing between working mediums is achieved in automatic or forced mechanical mode, at any rotor speed and without stopping the rotor. The engine is readily manufactured and easily operated, it does not require highly skilled operators, and can be started without a battery. Furthermore, the engine has a small number of friction-pair and wearing parts. Multiple rotor modules can be mounted on a common engine shaft, with a specific angle offset to eliminate vibration at any speed and avoid any additional engine balancing and adjusting operations.

1. An internal combustion engine run with a working medium, said engine comprising
a common shaft rotatable within the engine;
at least one module mounted on the common shaft, said at least one module including:
a substantially cylindrical rotor, having a rotor's longitudinal axis, said rotor coupled to said common shaft, said rotor furnished with a working vane and a suction vane for operating the working medium;
a substantially cylindrical stator stationed within the engine, said stator embracing said rotor, said stator having its longitudinal axis offset from the rotor's longitudinal axis;
a working chamber mounted on said stator;
a working mixture mixer coupled to the working chamber;
an ignition system coupled to the working chamber,
an exhaust means mounted on the stator;
a manhole mounted on the stator; and
a sealing means disposed within the manhole;
wherein said at least one module characterized in that said working chamber, mixer, and ignition system disposed outside of the stator and mounted to the stator so that being tangentially oriented to the stator, the sealing means performed spring-loaded so that being depressed against the external rotor surface providing predetermined sealing, the working and suction vanes performed spring-loaded so that being depressed against the internal stator surface providing additional sealing, thereby resulting in essential fuel efficiency and economy, and smooth operation of the engine.
